(19) United States
(12) Patent Application Publication
(10) Pub. No.: US 2004/0107591 A1
(43) Pub. Date: Jun. 10, 2004

(54) Steering wheel level device and method of making and using

(76) Inventor: Fredric T. Cuddy, Fayetteville, NC (US)

Correspondence Address: WILLIAM L. LONDON, 3010 LEE AVENUE, P.O. BOX 152, SANFORD, NC, 27330, US

(21) Appl. No.: 10/065,997

(22) Filed: Dec. 9, 2002

(51) Int. Cl. G01C 9/00

(52) U.S. Cl. 33/370

(57) ABSTRACT

A steering wheel level device and method of using and making the steering wheel level device are disclosed. The steering wheel level device may include a level indicator holder and a grip assembly. The grip assembly may be adapted to releasably affix the level indicator holder to different sizes and shapes of steering wheels.

### BACKGROUND OF INVENTION

### FIELD OF THE INVENTION

The present invention relates to vehicles, such as automobiles and the like, and repair and maintenance of such vehicles, and more particularly to a steering wheel level device and method of making and using the steering wheel level device to align wheels on the vehicle or other uses that may take advantage of the level device.

After paying for an expensive wheel alignment procedure, a driver or vehicle owner may be dissatisfied if the steering wheel of the vehicle does not feel or appear level or straight as the vehicle is driven in a straight line. Having a steering wheel that feels tilted when the vehicle is tracking in a straight line without any sensation in the steering wheel that the vehicle wants to veer to one side or another can be aggravating to a driver and in some circumstances may present a safety consideration.

When doing a wheel alignment procedure on a vehicle, a mechanic or technician may be advised in an instruction manual or by a computer operated alignment machine or the like to reposition the steering wheel in a level position at various times during the alignment procedure. The mechanic or technician will typically merely place the steering wheel in a position that appears to the mechanic's senses to be level or straight without using any sort of device to confirm that the steering wheel is level or straight in relation to the vehicle's front wheels or wheels coupled to the steering wheel that guide the vehicle. Accordingly, the steering wheel may actually be tilted compared to the actual alignment of the vehicle's wheels that guide the vehicle down the road.

Accordingly, there is a need to provide a device that permits a mechanic or technician to accurately level or straighten a steering wheel. There is also a need to provide a steering wheel level device that is simple to install and remove from a steering wheel and has a robust construction to withstand the environment of a garage or vehicle maintenance center. There is also a need to provide a steering wheel level device that has a simple construction and can be cost effectively manufactured.

### SUMMARY OF INVENTION

In accordance with an embodiment of the present invention, a steering wheel level device may include a level indicator holder, and a grip assembly adapted to releasably affix the level indicator holder to different sizes and shapes of steering wheels or the like.

In accordance with another embodiment of the present invention, a steering wheel level device may include a level indicator holder. The steering wheel level device may also include a first end grip and a second end grip. At least one of the first end grip or the second end grip may be adjustable to releasably affix the level indicator holder to different sizes and shapes of steering wheels.

In accordance with another embodiment of the present invention, a method of aligning wheels of a vehicle may include positioning a vehicle on an alignment machine or the like. A steering wheel level device may be releasably affixed to a steering wheel of the vehicle. An alignment procedure provided by the alignment machine or by an instruction manual may be followed, and the steering wheel may be leveled or straightened by using the steering wheel level device when instructed to do so by the alignment procedure.

In accordance with another embodiment of the present invention, a method of making a steering wheel level device may include forming a level indicator holder, and forming a grip assembly to releasably affix the level indicator to a steering wheel.

### BRIEF DESCRIPTION OF DRAWINGS

FIG. 1 is an illustration of a steering wheel level device attached to a steering wheel in accordance with an embodiment of the present invention.

FIG. 2 is a perspective view of a steering wheel level device in accordance with an embodiment of the present invention.

FIG. 3 is an exploded detailed view of a portion of a steering wheel level device in accordance with an embodiment of the present invention.

FIG. 4 is a partial cross-sectional view of a steering wheel level device in accordance with an embodiment of the present invention.

FIG. 5 is a partial cross-sectional view of a steering wheel level device in accordance with another embodiment of the present invention.

FIG. 6 is an illustration of an alignment machine for performing an alignment procedure on a vehicle using the steering wheel level device in accordance with an embodiment of the present invention.

FIG. 7 is a flow chart of a method of aligning wheels of a vehicle in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

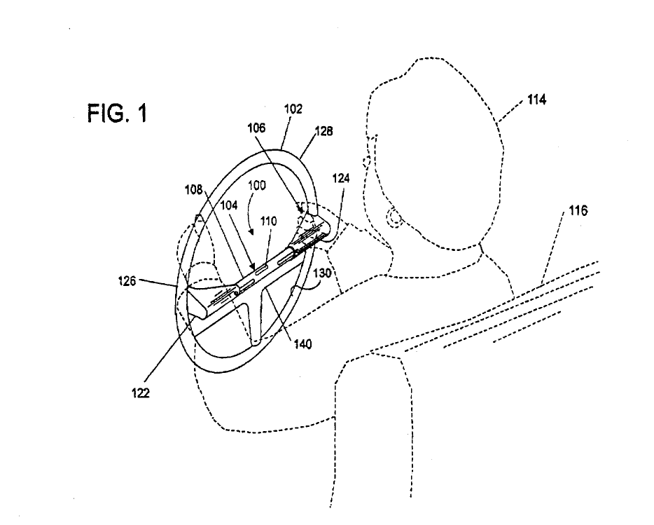

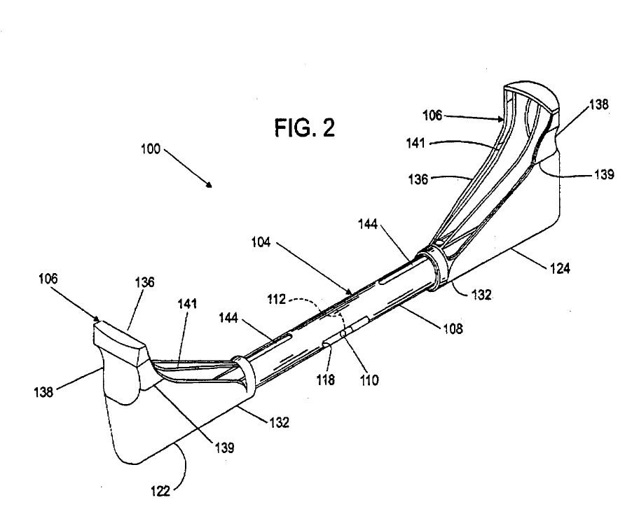

FIG. 1 is an illustration of a steering wheel level device 100 attached to a steering wheel 102 in accordance with an embodiment of the present invention. The steering wheel level device 100 may include a level indicator holder 104 and a grip assembly 106 adapted to releasably affix the level indicator 104 to the steering wheel 102. Referring also to FIG. 2, the level indicator holder 104 may include an elongated member 108, such as a rod or the like, and a level indicator 110 attached to the elongated member 108. The level indicator 110 may be attached proximate to a midpoint 112 (illustrated by the broken line in FIG. 2) of the elongated member 108. The level indicator 110 may also be attached in a position circumferentially on the elongated member 108 to cause the level indicator 110 to face a user, mechanic or technician 114 (FIG. 1) sitting in a driver's seat 116 of a vehicle (not shown in FIGS. 1 and 2) when the grip assembly 106 is releasably affixed to the steering wheel 102 of the vehicle.

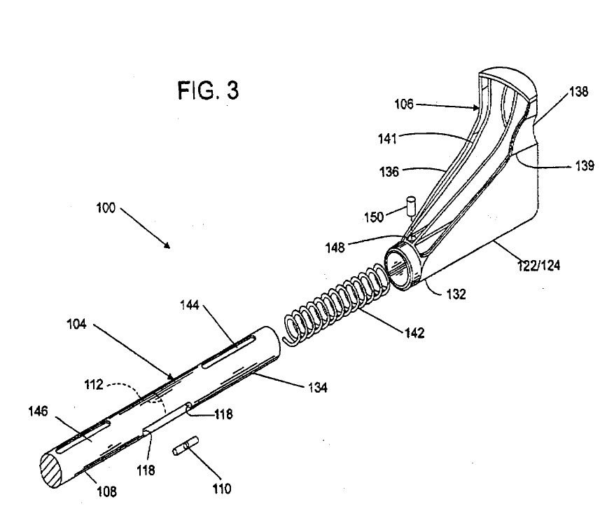

FIG. 3 is an exploded partial view of the steering wheel level device 100 in accordance with an embodiment of the present invention. A recess 118 may be formed in the elongated member 108 of the level indicator holder 104. The level indicator 110 may be a bubble level vial or the like and may be retained in the recess 118 by an adhesive or other means. The recess 118 may be formed proximate to the midpoint 112 of the elongated member 108. The recess 118 may also be positioned circumferentially on the elongated member 108 to cause the level indicator to face the user or mechanic 114 sitting in the driver's seat 116 when the grip assembly 106 is releasably affixed to the steering wheel 102 (FIG. 1).

Referring also to FIGS. 1 and 2, the grip assembly 106 may include a first end grip 122 and a second end grip 124. The first end grip 122 may be adapted to contact one side 126 of the steering wheel 102 and the second end grip 124 may be adapted to contact another side 128 of the steering wheel 102 (FIG. 1). The first end grip 122 and the second end grip 124 may each be adapted to contact an interior portion 130 of the steering wheel 102 (FIG. 1). At least one of the first end grip 122 or the second end grip 124 may be biased or adjustable to push the end grips 122 and 124 away from one another and against the interior portion 130 of the steering wheel 102 when the grip assembly 106 is releasably affixed to the steering wheel 102.

Referring back to FIG. 3, at least one or both end grips 122 and 124 may include a slide portion 132 that may be adapted to move relative to an end 134 of the level indicator holder 104. The level indicator holder 104 may be an elongated cylindrical rod and the slide portion 132 may be tubular or cylindrical to permit the one end 134 of the level indicator holder 104 to slidably move within the slide portion 132. While the level indicator holder 104 and the slide portion 132 are both shown to be substantially cylindrical in the Figures, other shapes and configurations could be used as well that permit the end grip 122 or 124 to move or slide relative to the level indicator holder 104 to permit the device 100 to be easily affixed and removed from the steering wheel 102 (FIG. 1).

A grip portion 136 may extend from the slide or tubular portion 132 and may be adapted to contact the steering wheel 102 (FIG. 1). The grip portion 136 may have a recess 138 formed therein to facilitate contacting the steering wheel 102. The recess 138 may extend around sides 139 of the grip portion 136 to rest on or contact any horizontal spokes 140 (FIG. 1) of the steering wheel 102. The recess 138 may insure proper positioning of the device 100 on the steering wheel 102 and level alignment with the steering wheel 102, particularly if resting on a horizontal spoke 140 of the steering wheel 102. The recess 138 may also aid in retention of the device 100 on the steering wheel 102 during an alignment procedure. The grip portion 136 may also include rib members 141 to provide robustness and support for the grip portion 136 and to aid in attachment of the grip portion 136 to the slide portion 132.

A spring 142, compressible fluid, compressible gas or a similar arrangement, may be adapted to bias the slide portion 132 relative to the level indicator holder 104. The spring 142 may be disposed inside the slide portion 132 to bias the elongated member or rod 108 of the level indicator holder 104 when the end 134 of the elongated member 108 is inserted into the slide portion 132 of the end grip 122 or 124. An elongated slot 144 may be formed in the elongated member 108 of the level indicator holder 104 proximate to the end 134 of the elongated member 108. If both end grips 122 and 124 are movable and biased relative to the level indicator holder 104, another elongated slot 146 may be formed in the elongated member 108 proximate to another end of the member 108. An opening or hole 148 may be formed in the slide portion 132 of the end grip 122/124. A retaining pin 150 may be inserted into the hole 148 and extended into the elongated slot 144. The retaining pin 150 may be slightly tapered or the hole 148 sized relative to the retaining pin 150 to cause the retaining pin 150 to be held in the hole 148. The retaining pin 150 may thereby be attached to the slide or tubular portion 132 with the retaining pin 150 extending into the slot 144 and thereby retaining the level indicator holder 104 within the slide or tubular portion 132 of the end grip 122/124. The retaining pin 150 may slide within the elongated slot 144 when the end grip 122/124 is moved relative to the level indicator holder 104. At least one of the end grips 122 or 124 may then be compressed to permit the steering wheel level device 100 to be easily attached and removed from a steering wheel of a vehicle, such as the steering wheel 102 in FIG. 1.

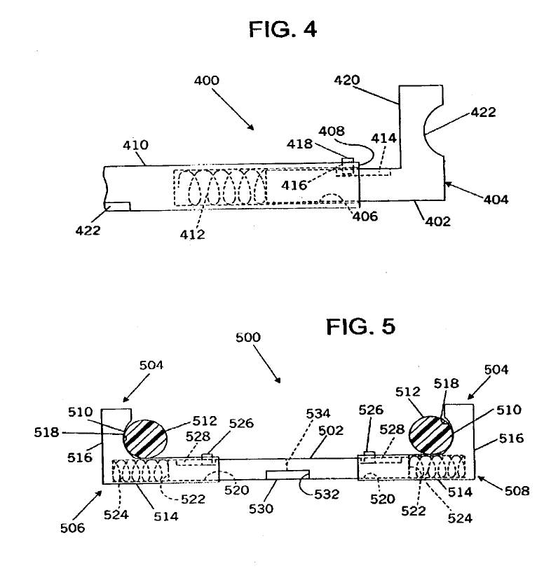

FIG. 4 is a partial cross-sectional view of a steering wheel level device 400 in accordance with another embodiment of the present invention. In the steering wheel level device 400, a slide or tubular portion 402 of an end grip 404 is adapted to slide within an opening 406 formed in an end 408 of a level indicator holder 410. A spring 412, compressible fluid, compressible gas or the like, may be disposed in the opening 406 to bias the slide portion 402 of the end grip 404 to facilitate releasably affixing the device 402 to a steering wheel. An elongated slot 414 may be formed in the slide portion 402. An opening or hole 416 may be formed in the level indicator holder 410 proximate to the end 408 of the holder 410. A retaining pin 418 may be attached to the level indicator holder 410 by inserting or driving the retaining pin 418 into the hole 416 with the retaining pin 418 extending into the slot 414 in the slide portion 402 of the end grip 404. The retaining pin 418 may be adapted to hold the slide portion 402 within the opening 406 in the level indicator holder 410. The retaining pin 418 may also be adapted to slide within the slot 414 when the end grip 404 is moved relative to the level indicator holder 410 to affix or remove the steering wheel level device 400 from a steering wheel.

The end grip 404 may also include a grip portion 420 extending from the slide portion 402. The grip portion 420 may have a recess 422 formed therein to provide a more robust or stable attachment of the steering wheel level device 400 to a steering wheel.

The steering wheel level device 400 may also include a level indicator 422 attached to the level indicator holder 402. The level indicator 422 may be attached proximate to a midpoint of the level indicator holder 410 and in a position to cause the level indicator 422 to face a user sitting in a driver's seat of a vehicle when the end grips 404 are releasably affixed to a steering wheel of the vehicle. The level indicator 422 may be a bubble level vial or the like.

FIG. 5 is a cross-sectional view of a steering wheel level device 500 in accordance with another embodiment of the present invention. The steering wheel level device 500 may include a level indicator holder 502 and a grip assembly 504. The grip assembly 504 may include a first end grip 506 and a second end grip 508. The first and second end grips 506 and 508 may each be adapted to contact an exterior portion 510 of a steering wheel 512. At least one of the end grips 506 or 508 may be biased to pull the end grips 506 and 508 toward one another to clamp the level indicator holder 502 to the steering wheel 512 when the grip assembly 504 is releasably affixed to the steering wheel 512.

Each end grip 506 and 508 may include a slide or tubular portion 514 and a grip portion 516 extending from the slide portion 514. The grip portion 516 of each end grip 506 and 508 may include a recess 518 to provide a more stable attachment to the steering wheel 512. The slide portion 514 of each end grip 506 and 508 may include an opening 520 into which an end 522 of the level indicator holder 502 may be received. A spring 524 or the like may be disposed in each opening 520 to bias each end grip 506 or 508 relative to the level indicator holder 502. A retaining pin 526 may be attached to each slide portion 514 and each retaining pin 526 may extend into an elongated slot 528 formed proximate to each end 522 of the level indicator holder 502. Each elongated slot 528 may capture a respective retaining pin 526 to retain the end grips 506 and 508 on the level indicator holder 502.

A level indicator 530, such as bubble level vial or the like, may be attached to the level indicator holder 502. A recess 532 may be formed in the level indicator holder 502 and the level indicator 530 may be held or retained in the recess 532. The level indicator 530 may be attached proximate to a midpoint 534 (illustrated by the broken line in FIG. 5) of the level indicator holder 502. The level indicator 530 may also be positioned relative to the grip assembly 504 to cause the level indicator 530 to face a user sitting in a driver's seat of a vehicle when the device 500 is releasably attached to a steering wheel, similar to the steering wheel 102 shown in FIG. 1.

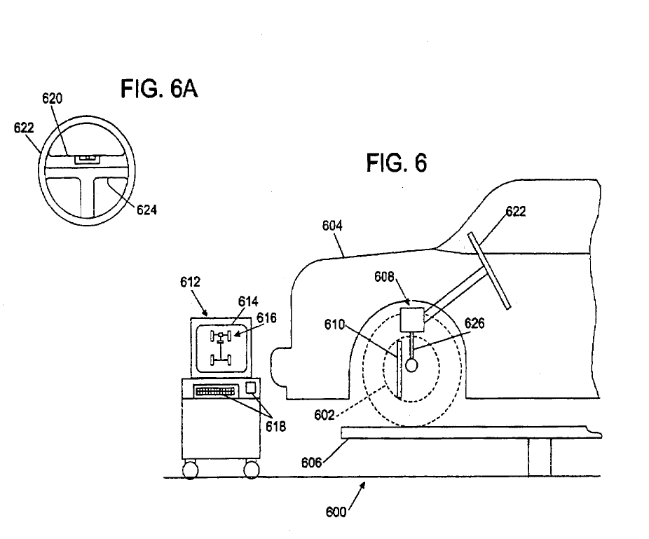

As previously discussed, the wheel level indicator device 100 of FIGS. 1-3, device 400 of FIG. 4 or device 500 of FIG. 5 may be used in aligning the wheels of a vehicle or the like. FIG. 6 is an illustration of an alignment machine 600 for aligning wheels 602 (shown in phantom in FIG. 6 for purposes of clarity) of a vehicle 604 in accordance with an embodiment of the present invention. The alignment machine 600 may be a Hunter Engineering Company Series 511™, Series 611™ or ExpressAlign™ alignment machine, as manufactured by the Hunter Engineering Company of Bridgeton, Mo., or the alignment machine 600 may be a similar alignment machine or apparatus. The present invention is not limited to any particular alignment machine or apparatus that may take advantage of the level device of the present invention. Briefly described, the alignment machine 600 may include a rack or vehicle hoist 606 to raise the vehicle 604 for a mechanic or technician to easily access the suspension system and steering mechanism 608 of the vehicle 604 for adjustment and repair. An alignment sensor 610 may be releasably attached to each wheel 602 to be aligned. The alignment machine 600 may also include a computer system 612 or the like to receive and process signals from the alignment sensor 610 to facilitate alignment of the wheel 602. The computer system 612 may include a display 614 on which instructions, a graphical user interface (GUI) or other images may be displayed to depict an alignment procedure 616. GUIs may be displayed on the display 614 to guide a technician step-by-step through the alignment procedure 616. The computer system 612 may also include an input device or devices 618, such as a keyboard, mouse or similar devices. The technician may control the alignment procedure 616 and enter information via the input devices 618.

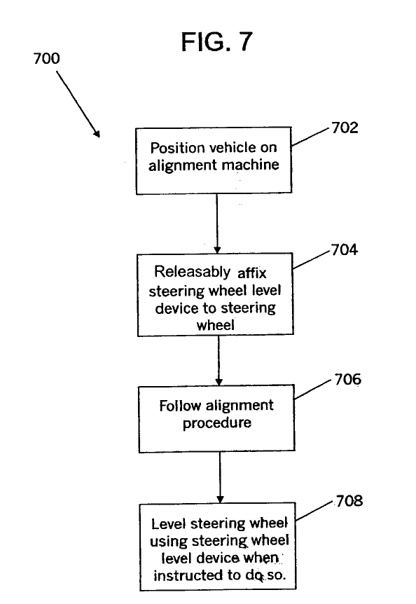

FIG. 7 is a flow chart of a method 700 of aligning the wheels of a vehicle, such as the vehicle 604 in FIG. 6, in accordance with an embodiment of the present invention. In block 702, the vehicle 604 may be positioned on the alignment machine 600. A steering wheel level device 620 (FIG. 6A), similar to device 100, 400 or 500 of FIGS. 1-5 or a similar device, may be releasably attached to a steering wheel 622 of the vehicle 604 in block 704 (FIG. 7). The steering wheel level device 620 may be positioned parallel to any horizontal spokes 624 of the steering wheel 622 and in contact with any horizontal steering wheel spokes 624 (FIG. 6A). Aligning the level device 620 with any horizontal spokes 624 and in contact with the spokes 624 may maintain the stability of the steering wheel level device 620 on the steering wheel 622 during the alignment procedure 616. Additionally, aligning the steering wheel level device 620 with horizontal spokes 624 may aid in accurately leveling of the steering wheel 622 during the alignment process 616 and improve customer satisfaction because the horizontal spokes 624 may provide visual queues or indications to a driver as to whether the steering wheel 622 is level or properly aligned. In block 706, a mechanic or technician may follow the wheel alignment procedure 616 as provided by the alignment machine 600 or an instruction manual for the alignment machine 600. In block 708, the mechanic may readjust or level the steering wheel 622 when instructed to do so by the alignment procedure 616 using the steering wheel level device 620 in accordance with an embodiment of the present invention. The steering wheel 622 may be readjusted or leveled by adjusting tie rods 626 or the like of the suspension system or steering mechanism 608 of the vehicle 604 (FIG. 6).

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A steering wheel level device, comprising:
a level indicator holder; and
a grip assembly adapted to releasably affix the level indicator holder to different sizes and shapes of steering wheels.

2. The steering wheel level device of claim 1, wherein the level indicator holder comprises:
an elongated member; and
a level indicator attached to the elongated member.

3. The steering wheel level device of claim 2, wherein the level indicator is attached proximate to a midpoint of the elongated member and in a position that will face a user sitting in a driver's seat of a vehicle when the grip assembly is releasably affixed to a steering wheel of the vehicle.

4. The steering wheel level device of claim 1, wherein the level indicator holder comprises:
an elongated member;
a recess formed in the elongated member; and
a level indicator retained in the recess.

5. The steering wheel level device of claim 4, wherein the recess is formed proximate to a midpoint of the elongated member and is positioned to cause the level indicator to face a user sitting in a driver's seat of a vehicle when the grip assembly is releasably affixed to a steering wheel of the vehicle.

6. The steering wheel level device of claim 1, wherein the level indicator is a bubble level vial.

7. The steering wheel level device of claim 1, wherein the grip assembly comprises:
a first end grip adapted to contact one side of a steering wheel; and
a second end grip adapted to contact another side of the steering wheel, wherein at least one of the first end grip or the second end grip is biased to releasably affix the level indicator holder to the steering wheel.

8. The steering wheel level device of claim 7, wherein the first end grip and the second end grip are each adapted to contact an interior portion of the steering wheel and wherein at least one of the first end grip or the second end grip is biased to push the end grips away from one another and against the interior portion of the steering wheel when the grip assembly is releasably affixed to the steering wheel.

9. The steering wheel level device of claim 7, wherein the first end grip and the second end grip are each adapted to contact an exterior portion of the steering wheel and wherein at least one of the first end grip or the second end grip is biased to pull the end grips toward one another to clamp the level indicator holder to the steering wheel when the grip assembly is releasably affixed to the steering wheel.

10. The steering wheel level device of claim 7, wherein at least one end grip comprises:
a slide portion adapted to move relative to one end of the level indicator holder; and
a grip portion extending from the slide portion and adapted to contact the steering wheel.

11. The steering wheel level device of claim 10, further comprising:
a spring adapted to bias the slide portion relative to the level indicator holder;
an elongated slot formed proximate to the one end of the level indicator holder; and
a retaining pin attached to the slide portion and adapted to slide within the elongated slot when the grip assembly is releasably affixed to the steering wheel.

12. A steering wheel level device, comprising:
a level indicator holder;
a first end grip; and
a second end grip, wherein at least one of the first end grip and the second end grip are adjustable to releasably affix the level indicator holder to different sizes and shapes of steering wheels.

13. The steering wheel level device of claim 12, wherein the level indicator holder comprises;
an elongated rod; and
a level indicator attached to the elongated rod.

14. The steering wheel level device of claim 13, wherein each of the end grips comprises:
a slide portion adapted to move relative to the elongated rod of the level indicator holder; and
a grip portion extending from the slide portion, wherein the grip portion of each end grip is positioned to cause the level indicator to face a user sitting in a driver's seat of a vehicle when the steering wheel level device is releasably affixed to the steering wheel.

15. The steering wheel level device of claim 12, wherein each end grip comprises:
a tubular portion, wherein each end of the level indicator holder is adapted to slidably move within a portion of the tubular portion; and
a grip portion extending from the tubular portion.

16. The steering wheel level device of claim 15, further comprising:
a spring disposed inside each tubular portion to bias the level indicator holder when slidably inserted into the tubular portion;
an elongated slot formed proximate to each end of the level indicator holder; and
a retaining pin attached to each tubular portion and extending into each elongated slot, wherein the retaining pin is adapted to retain the level indicator holder within the tubular portion and wherein the retaining pin is adapted to slide within the elongated slot when the end grip is moved relative to the level indicator holder.

17. The steering wheel level device of claim 12, wherein each end grip comprises:
a slide portion, wherein the slide portion is adapted to slidably move relative to the level indicator holder; and
a grip portion extending from the slide portion and adapted to contact the steering wheel.

18. The steering wheel level device of claim 17, further comprising:
a spring to bias the slide portion of the end grip relative to the level indicator holder;
an elongated slot formed in the slide portion; and
a retaining pin attached to the level indicator holder and extending into the elongated slot, wherein the retaining pin is adapted to slide within the elongated slot when the end grip is moved relative to the level indicator holder.

19. The steering wheel level device of claim 12, wherein the first end grip and the second end grip each comprise a recess to facilitate attachment to a steering wheel.

20. A method of aligning wheels of a vehicle, comprising:
positioning a vehicle on an alignment machine;
releasably affixing a steering wheel level device to a steering wheel of the vehicle;
following an alignment procedure provided by the alignment machine; and
leveling the steering wheel using the steering wheel level device when instructed to do so by the alignment procedure.

21. The method of claim 20, wherein releasably affixing the steering wheel level device to the steering wheel comprises contacting an interior portion of the steering wheel with end grips of the steering wheel device by compressing at least one grip end grip against the interior portion of one side of the steering wheel.

22. The method of claim 20, further comprising removing the steering wheel level device from the steering wheel by compressing one end grip to disengage the other end grip from contacting the steering wheel.

23. The method of claim 20, wherein releasably affixing a steering wheel level to the steering wheel comprises positioning the steering wheel level device parallel to any horizontal spokes of the steering wheel.

24. The method of claim 23, further comprising positioning the steering wheel level device in contact with any horizontal spokes.

25. The method of claim 20, wherein leveling the steering wheel comprises adjusting tie rods of the vehicle until the steering wheel level device indicates that the steering wheel is level.

26. A method of making a steering wheel level device, comprising:
forming a level indicator holder; and
forming a grip assembly to releasably affix the level indicator to a steering wheel.

27. The method of claim 26, wherein forming the level indicator holder comprises:
forming an elongated member; and
forming a level indicator attached to the elongated member.

28. The method of claim 27, further comprising attaching the level indicator proximate to a midpoint of the elongated member and in a position to face a user sitting in a driver's seat of a vehicle when the grip assembly is releasably affixed to a steering wheel of the vehicle.

29. The method of claim 26, wherein forming the grip assembly comprises:
forming a first end grip adapted to contact one side of a steering wheel; and
forming a second end grip adapted to contact another side of the steering wheel; and
biasing at least one of the first end grip or the second end grip to releasably affix the level indicator holder to the steering wheel.

30. The method of claim 29, wherein forming the first end grip comprises:
forming a slide portion adapted to move relative to one end of the level indicator; and
forming a grip portion extending from the slide portion and adapted to contact the steering wheel.

31. The method of claim 30, further comprising:
providing a spring to bias the slide portion relative to the level indicator holder;
forming an elongated slot proximate to the one end of the level indicator holder; and
attaching a retaining pin to the slide portion, wherein the retaining pin is adapted to slide within the elongated slot when the grip assembly is releasably affixed to the steering wheel.

32. The method of claim 26, further comprising:
forming a first end grip and a second end grip to contact an interior portion of the steering wheel; and
biasing at least one of the first end grip or the second end grip to push the end grips away from one another and against the interior portion of the steering wheel when the grip assembly is releasably affixed to the steering wheel.

33. The method of claim 26, further comprising:
forming a first end grip and a second end grip to contact an exterior portion of the steering wheel; and
biasing at least one of the first end grip or the second end grip to pull the end grips toward one another to clamp the level indicator holder to the steering wheel when the grip assembly is releasably affixed to the steering wheel.
